(19) United States
(12) Patent Application Publication
(10) Pub. No.: US 2006/0028150 A1
(43) Pub. Date: Feb. 9, 2006

(54) Circuitry and methodology for driving multiple light emitting devices

(75) Inventors: Mark Robert Vitunic, Lexington, MA (US); Steven Leo Martin, Lowell, MA (US)

Correspondence Address: MCDERMOTT WILL & EMERY LLP, 600 13TH STREET, N.W., WASHINGTON, DC, 20005-3096, US

(73) Assignee: LINEAR TECHNOLOGY CORPORATION

(21) Appl. No.: 10/911,703

(22) Filed: Aug. 5, 2004

(51) Int. Cl. H05B 41/24

(52) U.S. Cl. 315/248

(57) ABSTRACT

High efficiency drive circuitry for a group of parallel-connected light emitting devices, in which each device is driven in series by a respective source of bias current. The maximum voltage drop among the group of biased light emitting devices is determined and in response, a control voltage to drive all the light emitting device at the lowest effective voltage for the LED group is produced.

### TECHNICAL FIELD

The disclosure relates to circuitry and methodology for driving multiple light emitting devices, such as light emitting diodes, and more particularly to novel circuitry and methodology for regulating a voltage for driving multiple light emitting devices in which the lowest voltage effective for driving all the light emitting devices is generated.

### DESCRIPTION OF RELATED ART

White light emitting diodes (LEDs) are widely used for displays of handheld devices, such as PDAs (Personal Digital Assistants) and cellular phones. One of the characteristics of white LEDs is their relatively high forward voltage drops, and in fact, the forward voltage drops of white LEDs are relatively close to battery voltage. Accordingly, the efficiency of driving white LEDs is an important factor to, for example, extend battery life in handheld applications.

Modern techniques for driving white LEDs in handheld applications generally employ one of two types of regulators: charge pumps and inductor-based boost converters. Both types of regulators “step-up” an input voltage (for example, a Li-Ion battery) to a higher voltage required to bias the LEDs. Charge pumps achieve their highest efficiency at an output voltage equal to the input voltage times the amount of “step-up.” In a white LED application, if the voltage necessary to drive white LEDs is less than the output voltage at which the highest efficiency is achieved, the additional voltage generated by charge pumps represents an effective efficiency loss. For this reason, the effective efficiency of charge pumps in a white LED application has a strong dependence on input voltage (which varies with 1/Vin). Multi-mode charge pumps improve upon effective efficiency at the expense of additional circuitry and cost. On the other hand, it has been known that inductor-based DC-DC converters can attain a higher level of performance than those achievable with charge pumps including multi-mode charge pumps. Among inductor-based DC-DC converters, buck-boost DC-DC converters are considered to be the most robust in terms of input and output voltage range.

In implementing a white LED display, for example, multiple white LEDs are connected in series or parallel to the output of a regulator. A series connection of multiple LEDs, while providing perfect current matching, requires the regulator to generate a much higher output voltage to drive the white LEDs. This scheme has a disadvantage of requiring more expensive components to withstand the higher voltage. In addition, in the case where inductor-based DC-DC converters are employed, efficiency at higher output to input voltage ratios is reduced. A series connection also has the proverbial “Christmas-tree light problem.” A failure in one component affects the whole string. On the other hand, driving multiple LEDs in parallel eliminates the high voltage issue and makes higher efficiency attainable, but requires ballasting to achieve good current matching.

### BRIEF SUMMARY OF THE INVENTION

The disclosed subject matter maximizes power efficiency when driving multiple, parallel connected, light emitting devices, such as white light emitting diodes (LEDs), by generating the lowest effective drive voltage.

The disclosed subject matter also provides circuitry including elements configured and selected for maximizing power efficiency when driving multiple, parallel connected light emitting devices.

In one aspect of the disclosure, circuitry for driving multiple parallel-coupled light emitting devices connected to an output node comprises a voltage regulator for controlling the output node, and a control circuit for controlling the regulator to produce substantially a lowest output voltage effective to drive that one of the light emitting devices having the highest forward voltage drop.

In accord with another aspect, the circuit may comprise a voltage regulator for controlling an output node, and bias circuitry for setting a level of current through each light emitting device. The light emitting devices are to be connected in circuit with the output node and bias circuitry. Regulator control circuitry is arranged for controlling the voltage regulator to maintain an operating voltage across the bias circuitry to produce substantially a lowest output voltage effective to drive that one of the light emitting devices having the highest forward voltage drop.

In accord with another aspect of the disclosure, a drive circuit controls a regulator for regulating a power supply voltage to be supplied to a power supply node to which multiple light emitting devices are connected in parallel. Bias circuits are connected in series with the respective light emitting devices. The drive circuit may include a detection circuit configured for receiving signals from the respective bias circuits, and in response, detecting which one of the light emitting devices being biased has the highest forward voltage drop based on the signals. The drive circuit further includes a control circuit coupled to the detection circuit and configured for generating a control signal to control the regulator to produce substantially a lowest voltage effective to drive that one of the light emitting devices having the highest forward voltage drop.

In one embodiment, the signals each indicate a voltage at a corresponding node in each bias circuit. The corresponding node carrying the highest voltage among the nodes indicates which one of the light emitting devices being biased has the highest forward voltage drop. The detection circuit may be configured for detecting the highest voltage, and may comprise an OR-circuit including multiple NPN-transistors, bases of which receive the signals from the bias circuits, respectively, to output a voltage corresponding to the highest voltage.

The control circuit may be configured for comparing the highest voltage detected by the detection circuit with a predetermined reference voltage, and in response, generating the control signal. The control circuit may be a first transconductance amplifier configured for sourcing or sinking a current as the control signal based on the difference between the highest voltage and the reference voltage. The reference voltage is selected so as to control the regulator to produce substantially the lowest output voltage to drive the one of the light emitting devices having the highest forward voltage drop.

The drive circuit can include a second transconductance amplifier configured for sinking a predetermined amount of the current being sourced from the first transconductance amplifier when the output voltage at the output node exceeds a predetermined voltage.

Alternatively, the detection circuit may be configured for detecting the lowest voltage when the corresponding node carrying the lowest voltage among the nodes indicates which one of the light emitting devices being biased has the highest forward voltage drop. In this case, the detection circuit may comprise an OR-circuit including multiple PNP-transistors, bases of which receive the signals from the bias circuits, respectively, to output a voltage corresponding to the lowest voltage.

The control circuit may also be configured for comparing the lowest voltage detected by the detection circuit with a predetermined reference voltage, and in response, generating the control signal. The reference voltage is selected so as to control the regulator to produce substantially the lowest output voltage effective to drive that one of the light emitting devices having the highest forward voltage drop.

The drive circuit may further include a selector, connected between the detection circuit and the control circuit, for comparing the lowest voltage from the detection circuit with a scaled down voltage obtained by scaling down the output voltage at the output node to select the highest voltage. The control circuit may be configured for comparing the highest voltage selected by the selector with the reference voltage.

In another aspect of the disclosure, there is provided detector circuitry comprising input nodes and a detection circuit. The input nodes are arranged for receiving signals from bias circuits connected in series with multiple light emitting devices, respectively, in which the light emitting devices are connected in parallel to a power supply node. The detection circuit is responsive to the signals on the input nodes for detecting which one of the light emitting devices being biased has the highest forward voltage drop.

In yet another aspect of the disclosure, there is provided a method for driving multiple light emitting devices connected in parallel to a power supply node and each connected in series to respective bias circuits for biasing the light emitting devices. A power supply voltage to be applied to the power supply node is regulated. Signals from the respective bias circuits are received, and then based on the signals it is detected as to which one of the light emitting devices being biased has the highest forward voltage drop. In response, a control signal to control the regulating step is generated such that the power supply voltage is caused to attain the lowest voltage effective to drive that one of the light emitting devices having the highest forward voltage drop.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawing and in which like reference numerals refer to similar elements and in which:

FIG. 1 is a block diagram showing a basic configuration of a driving circuit for driving multiple LEDs.

FIG. 2 is a circuit diagram of a low dropout current source for biasing each LED.

FIG. 3 is a detailed circuit diagram of the driving circuit shown in FIG. 1.

FIG. 4 is a detailed circuit diagram showing a maximum voltage detector and transconductance amplifiers shown in FIG. 3.

FIG. 5 is a circuit diagram showing an alternative embodiment of the driving circuit.

### DETAILED DESCRIPTION

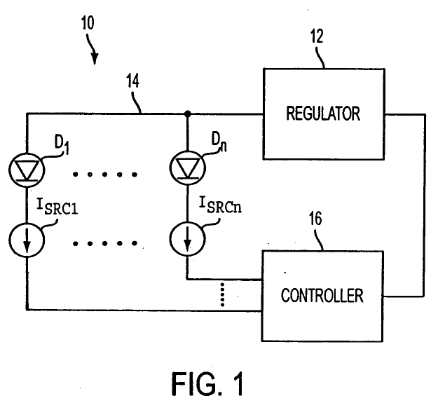

FIG. 1 shows a basic configuration of a driving circuit for driving multiple LEDs, such as white LEDs. A driving circuit 10 includes a regulator 12 regulating an output voltage to be applied to an output node 14 to which multiple LEDs D₁ to Dₙ are connected in parallel. Each of LEDs D₁ to Dₙ may be connected in series with ballasting such as a current source (I_{SRC1}, I_{SRCn}) for controlling currents for LEDs D₁ to Dₙ.

The forward voltage drop across each of LEDs D₁ to Dₙ may be different from each other due to normal manufacturing variations or unequal current biasing. Regulator 12 thus must generate an output voltage sufficiently high to bias all of LEDs D₁ to Dₙ, at a magnitude that is as low as possible for maintaining high power efficiency. A principle employed in this disclosure is to obtain the highest power efficiency by determining which one of LEDs D₁ to Dₙ being biased has the highest forward voltage drop and to control all LEDs D₁ to Dₙ based on that LED with the highest forward voltage drop.

In FIG. 1, a controller 16 determines which one of multiple LEDs D₁ to Dₙ being biased has the highest forward voltage drop. Then, controller 16 generates a control signal for closing a regulation loop on such a particular LED. Controller 16 controls regulator 12 so that the lowest output voltage effective to drive the LED with the highest forward voltage drop is applied to output node 14. This lowest output voltage represents the magnitude of a driving voltage that is as low as possible, yet high enough to drive (bias) effectively all LEDs D₁ to Dₙ.

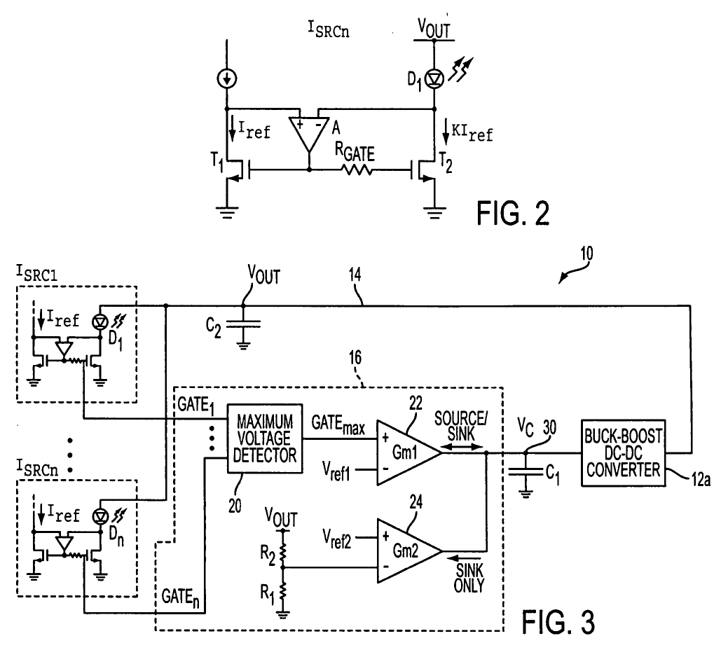

The described embodiment implements a conventional, ballasted current source in series with each of LEDs D₁ to Dₙ, for providing a drive current to each device. By way of example, FIG. 2 shows an embodiment of current source I_{SRCn} for controlling current to LED D₁. Current source I_{SRCn} may include n-type MOS transistors T_{1 and T}₂, and an amplifier A which together constitute a current mirror for biasing LED D₁.

The drain of transistor T₁ is connected to the noninverting input of amplifier A, the drain of transistor T₂ is connected to the inverting input of amplifier A, and the output of amplifier A is connected to gates of transistors T_{1 and T}₂ which are tied together. A resistor R_{GATE} is included for stability, and does not affect the DC operation of current source I_{SRCn}.

A reference current I_{ref} is mirrored with gain K by transistors T_{1 and T}₂ to cause a program current KI_{ref} to flow through LED D₁. Amplifier A servos the gate voltage of transistor T₁ to keep it biased at reference current I_{ref}, and causes the drain voltage of transistor T₁ to match the drain voltage of transistor T₂. This allows transistor T₂ to operate in the triode or linear region with a low absolute drain voltage while still matching the drain current of transistor T₁. As persons skilled in the art understand, the factor K is a function of the geometries of transistors T₁, T₂.

This current source I_{SRCn} is specifically designed for low dropout operation, because it enables transistor T₂ to operate with a low absolute drain voltage. By combining this current source with the scheme in this disclosure, highly effective driving voltage regulation is achievable by maintaining the voltage across the current source to be as low as possible, but large enough to control its LED to emit light at a rated level.

In this embodiment, MOS transistors are used to form a specific current mirror circuit, as depicted. However, it is apparent to persons skilled in this art that current mirrors with different configurations, for example, by employing bipolar transistors, or using different circuit topologies, could be implemented.

FIG. 3 is a more detailed diagram of an exemplary embodiment of driving circuit 10 shown in FIG. 1. Referring to FIG. 3, control circuit 16 is configured to receive signals from respective current sources I_{SRC1} to I_{SRCn}, each having the same configuration as that of current source I_{SRCn} shown in FIG. 2. As described above, control circuit 16 first determines which one of LEDs D₁ to Dₙ has the highest forward voltage drop. For such a determination, since the drain and gate voltages are linear and reciprocal functions, respectively, of the forward voltage drops of LEDs, either the drain voltages or the gate voltages of these transistors can be monitored. In the embodiment depicted, control circuit 16 receives the gate voltages GATE₁ to GATEₙ of transistors T₂ in respective current sources I_{SRC1} through I_{SRCn}, to detect which one of the LEDs has the highest forward voltage drop. Since each of current sources I_{SRC1} to I_{SRCn} is biased from the same reference current I_{ref}, the highest gate voltage among gate voltages GATE₁ to GATEₙ corresponds to the lowest counterpart drain voltage of transistor T₂ in any of current sources I_{SRC1} to I_{SRCn}. This, in turn, identifies which one of the LEDs has the highest forward voltage drop. For example, a typical drain voltage is 50 to 100 mV.

It will be appreciated that the detection circuit implemented to determine which one of the LEDs has the highest forward voltage drop is not limited to the above configuration. Other configurations are possible, depending, for example, on topology of current source employed.

To make the maximum gate voltage determination, controller 16 may include a maximum voltage detector (or selector) 20 and transconductance amplifiers 22 and 24. Maximum voltage detector 20 is configured for receiving the gate voltages GATE₁ to GATEₙ from respective current sources I_{SRC1} to I_{SRCn}, and detecting the highest of gate voltages GATE₁ to GATEₙ. Maximum voltage detector 20 outputs a voltage GATEₘₐₓ corresponding to the highest gate voltage detected. Voltage GATEₘₐₓ from maximum voltage detector 20 is supplied to the noninverting input of transconductance amplifier 22, in which the inverting input receives a reference voltage V_{ref1}. The output of transconductance amplifier 22 is connected to a capacitor C₁ at a node 30. Capacitor C₁ connected between node 30 and ground is a compensation capacitor for the regulation loop and provides a control voltage V_{c} to a buck-boost DC-DC converter 12a that carries out regulation of voltage V_{OUT} for supply to the LEDs D₁ to Dₙ.

Reference voltage V_{ref1} is selected so as to control the regulation loop to produce substantially the lowest output voltage effective to drive the one of LEDs D₁ to Dₙ having the highest voltage drop. In the case where current sources I_{SRC1} to I_{SRCn} are employed, reference voltage V_{ref1} can be determined based on internal characteristics of amplifier A in each of current sources I_{SRC1} to I_{SRCn}. As described above, voltage GATEₘₐₓ corresponds to the lowest drain voltage from among transistors T_{1 and T}₂ in any of current source I_{SRC1} to I_{SRCn} In other words, the higher the gate voltage, the lower the drain voltage. Therefore, the highest possible voltage can be selected as reference voltage V_{ref1}, on condition that amplifier A is able to operate in its high-gain common mode range, i.e., the active region, when voltage GATEₘₐₓ is equal to reference voltage V_{ref1}. Otherwise, each of current sources I_{SRC1} to I_{SRCn} cannot enable transistor T₂ to operate with a low absolute drain voltage while matching the drain current of transistor T₁. It is desirable to set reference voltage V_{ref1} so that amplifier A can operate in a higher region within its output common mode range.

The regulation loop servos output voltage V_{OUT} at node 14 to a voltage such that voltage GATEₘₐₓ will be equal to reference voltage V_{ref1}. When the voltage GATEₘₐₓ is higher than reference voltage V_{ref1}, transconductance amplifier 22 sources current to node 30. On the other hand, when voltage GATEₘₐₓ is lower than reference voltage V_{ref1}, transconductance amplifier 22 sinks current from node 30. Control voltage V_{c} for buck-boost DC-DC circuit 12a accordingly varies depending on the sourcing and sinking currents of transconductance amplifier 22.

Drive circuit 10 may further include a transconductance amplifier 24, provided as an active clamp to prevent output voltage runaway that may occur if any of LEDs D₁ to Dₙ becomes open-circuited. Transconductance amplifier 24 has an inverting input coupled to a junction of resistors R₁ and R₂ and a noninverting input coupled to a reference voltage V_{ref2}. Transconductance amplifier 24 may be designed so that when voltage V_{OUT} rises to [V_{ref2} (R₂+R₁)/R₁], the amplifier starts sinking a current equivalent in magnitude to the maximum current that amplifier 22 would be sourcing with one or more LEDs open-circuited. The level of [V_{ref2}(R₂+R₁)/R₁] is placed comfortably away from the anticipated LED forward voltage so that amplifier 24 does not interfere in normal operation. Reference voltage V_{ref2}, and resistors R₁ and R₂ can be determined so as to comport with conditions adopted for drive circuit 10.

Buck-boost DC-DC converter 12a is supplied with control voltage V_{c} controlled by transconductance amplifier 22 so as to produce the lowest drive voltage for that particular LED having the highest forward voltage drop. In general, a buck-boost DC-DC converter operates in buck mode, boost mode or buck-boost mode. In buck mode, the converter regulates an output voltage that is less than the input voltage. In the boost mode, the regulator regulates an output voltage that is greater than the input voltage. In buck and boost modes, fewer than all of the internal switches are switched ON and OFF to regulate the output voltage, to conserve power. In buck-boost mode, all of the switches switch ON and OFF to regulate the output voltage to a value that is greater than, less than, or equal to the input voltage. A buck-boost DC-DC converter is disclosed in U.S. Pat. No. 6,166,527 in detail, which is hereby incorporated by reference. Of course, other types of inductor-based DC-DC converters as well as charge pumps can be adopted to driving circuit 10, instead of a buck-boost DC-DC converter.

Further, drive circuit 10 may include a capacitor C₂ connected between node 14 and ground, which serves as an output bypass capacitor holding a DC output voltage. When buck-boost DC-DC converter 12a does not deliver current, capacitor C₂ delivers current to the load, i.e., LEDs D₁ to Dₙ.

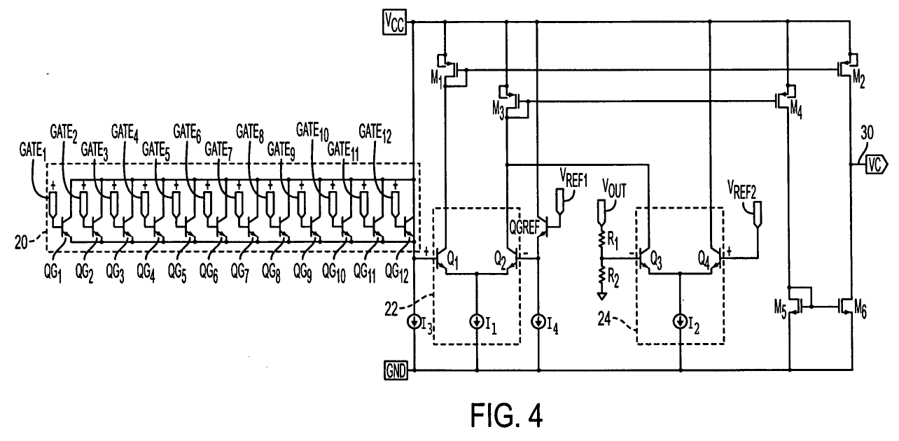

FIG. 4 shows an example of a circuit configuration of maximum voltage detector 20 and transconductance amplifiers 22 and 24, which are provided between power supply voltages Vcc and GND.

Maximum voltage detector 20 comprises an OR-circuit including a plurality of NPN-transistors QG₁ to QG₁₂. In FIG. 4, maximum voltage detector 20 is configured on the assumption that there are 12 current sources. All bases of transistors QG₁ to QG₁₂ are tied to potentially different voltages, respectively, i.e., gate voltages GATE₁ to GATEₙ from respective current sources I_{SRC1} to I_{SRCn}. All emitters of transistors QG₁ to QG₁₂ are tied together. In maximum voltage detector 20, that base voltage of that one of transistors QG₁ to QG₁₂ which is the highest will be the one determining the voltage at the connected emitters (GATEₘₐₓ shown in FIG. 3). For example, when the base of transistor QG₁ is of voltage 100 mV higher in magnitude than the other bases, then transistor QG₁ will conduct current I₃, and the others are essentially turned off. Therefore, the DC level-shifted highest gate voltage, GATEₘₐₓ, can be obtained.

Transconductance amplifier 22 is implemented by NPN differential pair transistors Q₁ and Q₂ with a tail current I₁ and transconductance amplifier 24 is similarly implemented by NPN differential pair transistors Q₃ and Q₄ with a tail current I₂.

The DC level-shifted GATEₘₐₓ voltage produced by maximum voltage detector 20 in FIG. 4 is coupled to the non-inverting input of transconductance amplifier 22. In FIG. 4, the GATEₘₐₓ voltage is level-shifted by the one of transistors QG₁ to QG₁₂ receiving the highest gate voltage, i.e., GATEₘₐₓ=V_{IN}−V_{BE}. Thus, transistor QGREF, being biased with current source 14, level-shifts the reference voltage V_{ref1} to (V_{ref1}−V_{BE}) so that the GATEₘₐₓ voltage and reference voltage V_{ref1} are appropriately compared by transconductance amplifier 22.

Pairs of transistors M₁-M₂, M₃-M₄ and M₅-M₆ constitute current mirrors for performing appropriate summing of currents at node 30, for producing control voltage V_{c} to buck-boost DC-DC converter 12a. The collector current of transistor Q₁ is mirrored by transistors M₁ and M₂ with unity gain, which represents a sourcing current to node 30. Transistor Q₂ collector current is mirrored by transistors M₃ and M₄ with unity gain, and mirrored again by transistors M₅ and M₆ with unity gain, which represents a sinking current from node 30. A point of balance is obtained when the current M₂ sourcing to node 30 is equal to the current M₆ sinking from node 30. In such a case, the collector currents of transistors Q₁ and Q₂ are equal, and thus, the GATEₘₐₓ voltage and reference voltage Vren are equal. In this condition, the lowest voltage to drive LEDs D₁ to Dₙ is applied to output node 14 by buck-boost DC-DC converter 12a.

As described above, drive circuit 10 drives LEDs D₁ to Dₙ based on that particular LED having the highest forward voltage drop. Drive circuit 10 controls the output voltage to be the lowest voltage effective to drive such a particular LED having the highest forward voltage drop. Although the voltage is the lowest for that particular LED, the voltage is high enough to drive all the parallel connected LEDs. Therefore, power efficiency for driving multiple LEDs is improved because the lowest effective drive voltage driving all the LEDs is applied to output node 14. In addition, by employing a buck-boost DC-DC converter and a low dropout current source as shown in FIG. 2, power efficiency can be maximized.

Alternative Embodiment

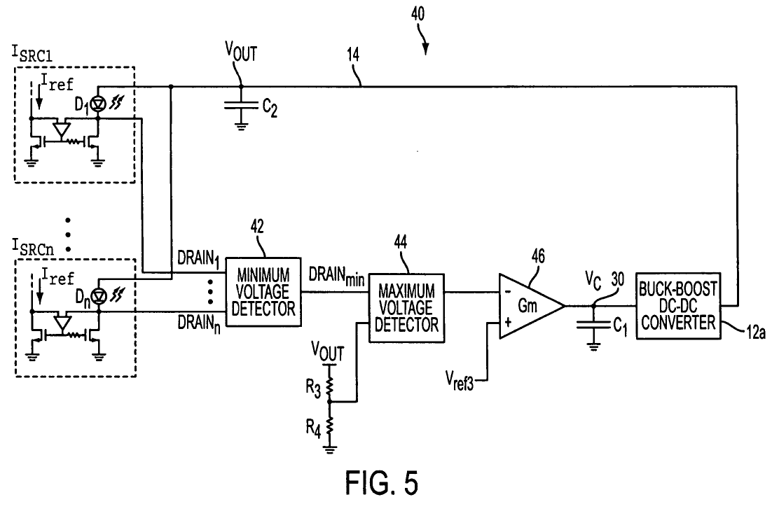

FIG. 5 shows an alternative embodiment of driving circuit 10 utilizing the drain voltages of transistors T_{1 and T}₂ within current sources I_{SRC1} to I_{SRCn}, rather than the gate voltages for the same purpose. As explained, the lowest drain voltage among current sources I_{SRC1} to I_{SRCn} identifies which one of LEDs D₁ to Dₙ being biased has the highest forward voltage drop.

Referring to FIG. 5, driving circuit 40 includes a minimum voltage detector (or selector) 42 to detect the lowest of drain voltages DRAIN1 to DRAINn among respective transistors T_{1 and T}₂ of current source I_{SRCn} in FIG. 2. Accordingly, a voltage DRAINₘᵢₙ corresponding to the lowest drain voltage is output from minimum voltage detector 42. Minimum voltage detector 42 can be implemented by using an OR-circuit including multiple PNP-transistors, which is of a configuration complementary to that of maximum voltage detector 20 shown in FIG. 4.

Driving circuit 40 further includes a maximum voltage detector 44 which receives the voltage DRAINₘᵢₙ from the minimum voltage detector 42 and a scaled down voltage obtained by dividing output voltage V_{OUT} at resistors R₃ and R₄ forming a voltage divider. Maximum voltage detector 44 detects or selects the higher of the voltage DRAINₘᵢₙ and the scaled down voltage. As explained in more detail below, this maximum voltage detector 44 acts as an active clamp. The output of maximum voltage detector 44 is provided to an inverting input of a transconductance amplifier 46 whose noninverting input is coupled to a reference voltage V_{ref3}. Similar to amplifier 22 in FIGS. 3 and 4, transconductance amplifier 46 provides current to node 30 according to the difference between reference voltage V_{ref3} and the output from maximum voltage detector 44, to control buck-boost DC-DC converter 12a.

Reference voltage V_{ref3} is selected so as to control the regulation loop to produce substantially the lowest output voltage to drive effectively that LED having the highest forward voltage drop. In the case where current sources I_{SRC1} to I_{SRCn} are employed, reference voltage V_{ref3} can be determined based on internal characteristics of amplifier A in each of current sources I_{SRC1} to I_{SRCn}. The lower the drain voltage, the lower the driving voltage necessary to drive the LED having the highest forward voltage drop. Therefore, the lowest possible voltage can be selected as reference voltage V_{ref3}, on condition that amplifier A is able to operate in its high-gain common mode range, i.e., an active region, when an output voltage from maximum voltage detector 44 (voltage DRAINₘᵢₙ or the scaled down voltage) becomes equal to reference voltage V_{ref}. Otherwise, current sources I_{SRC1} to I_{SRCn} cannot enable transistors T₂ to operate with a low absolute drain voltage while matching the drain current of transistor T₁. It is desirable to set reference voltage V_{ref3} so that amplifier A can operate in a lower range within its input common mode range.

Maximum voltage detector 44 prevents an excessive voltage from being applied to output node 14. When one of LEDs D₁ to Dₙ is open-circuited, the corresponding one of drain voltages DRAIN₁ to DRAINₙ collapses to ground, and in response, voltage DRAINₘᵢₙ from minimum voltage detector 42 will be at ground voltage. If ground voltage is input to transconductance amplifier 46, the amplifier sources more current to node 30. This results in an increased output from buck-boost DC-DC converter 12a. However, even if one of voltages DRAIN₁ to DRAINₙ collapses to ground, the maximum voltage detector 44 selects the scaled down voltage rather than voltage DRAINₘᵢₙ having the ground voltage. Accordingly, the scaled down voltage is input to transconductance amplifier 46, so that the regulation loop is properly maintained.

As described above, driving circuit 40 uses two different regulation loops. The first regulation loop is controlled based on voltage DRAINₘᵢₙ from minimum voltage detector 42. The second regulation loop is controlled based on the scaled down voltage input to maximum voltage detector 44.

It will be appreciated that values of resistor R₃ and R₄ forming the voltage divider can be selected in accordance with reference voltage V_{ref3} in order to properly regulate the regulation loop.

Further, in the above embodiment, the driving circuit is described in the context of driving multiple LEDs such as white LEDs. However the disclosed subject is not limited to white LEDs, but can be applied to drive any kind of light emitting devices including but not limited to red and blue LEDs.

In this disclosure there are shown and described only preferred embodiments of the invention and but a few examples of its versatility. It is to be understood that the invention is capable of use in various other combinations and environments and is capable of changes or modifications within the scope of the inventive concept as expressed herein.

1. Circuitry for driving multiple parallel-coupled light emitting devices connected to an output node in which each light emitting device is biased by a respective bias circuit, the circuitry comprising:
a regulator configured for regulating an output voltage to be applied to the output node;
a detection circuit configured for receiving signals from the respective bias circuits, and in response, detecting which one of the light emitting devices being biased has the highest forward voltage drop; and
a control circuit coupled to the detection circuit and configured for generating a control signal to control the regulator to produce substantially a lowest output voltage effective to drive that one of the light emitting devices having the highest forward voltage drop.

2. The circuitry according to claim 1, wherein
the signals each indicate a voltage at a corresponding node in each bias circuit, and the node carrying the highest voltage among the corresponding nodes indicates which one of the light emitting devices being biased has the highest forward voltage drop, and
the detection circuit is configured for detecting the highest voltage.

3. The circuitry according to claim 2, wherein
the detection circuit comprises an OR-circuit including multiple NPN-transistors, bases of which receive the signals from the bias circuits, respectively, to output a voltage corresponding to the highest voltage.

4. The circuitry according to claim 2, wherein
the control circuit is configured for comparing the highest voltage detected by the detection circuit with a predetermined reference voltage, and in response, generating the control signal, and
the reference voltage is selected so as to control the regulator to produce substantially the lowest output voltage to drive that one of the light emitting devices having the highest forward voltage drop.

5. The circuitry according to claim 4, wherein
the control circuit comprises a first transconductance amplifier configured for sourcing or sinking a current as the control signal based on the difference between the highest voltage and the reference voltage.

6. The circuitry according to claim 5, further comprising
a second transconductance amplifier configured for sinking a predetermined amount of the current being sourced from the first transconductance amplifier when the output voltage at the output node exceeds a predetermined voltage.

7. The circuitry according to claim 4, wherein
the bias circuits each include MOS transistors and an amplifier for constituting a current mirror, in which a reference current is mirrored with a gain of K by the transistors to cause a current to flow through a light emitting device connected to the output node, drains of the transistors are connected to respective inputs of the amplifier, an output of the amplifier is connected to gates of the transistors, and the amplifier maintains drain and gate voltages of one of the transistors to be equal to those of another, and
the reference voltage is set to be the highest possible voltage to enable the amplifier in each bias circuit to operate in its high-gain common mode range.

8. The circuitry according to claim 7, wherein
the corresponding nodes are coupled for obtaining the gate voltages of the transistors.

9. The circuitry according to claim 1, wherein
the signals each indicate a voltage at a corresponding node in each bias circuit, and that node carrying the lowest voltage among the corresponding nodes indicates which one of the light emitting devices being biased has the highest forward voltage drop, and
the detection circuit is configured for detecting the lowest voltage.

10. The circuitry according to claim 9, wherein
the detection circuit comprises an OR-circuit including multiple PNP-transistors, bases of which receive the signals from the bias circuits, respectively, to output a voltage corresponding to the lowest voltage.

11. The circuitry according to claim 9, wherein
the control circuit is configured for comparing the lowest voltage detected by the detection circuit with a predetermined reference voltage, and in response, generating the control signal, and
the reference voltage is selected so as to control the regulator to produce substantially the lowest output voltage to drive that one of the light emitting devices having the highest forward voltage drop.

12. The circuitry according to claim 11, further comprising
a selector, connected between the detection circuit and the control circuit, for comparing the lowest voltage from the detection circuit with a scaled down voltage obtained by scaling down the output voltage at the output node to select the highest voltage, wherein
the control circuit is configured for comparing the highest voltage selected by the selector with the reference voltage.

13. The circuitry according to claim 11, wherein
the bias circuits each include MOS transistors and an amplifier for constituting a current mirror, in which a reference current is mirrored with a gain of K by the transistors to cause a current to flow through a light emitting device connected to the output node, drains of the transistors are connected to respective inputs of the amplifier, an output of the amplifier is connected to gates of the transistors, and the amplifier maintains drain and gate voltages of one of the transistors to be equal to those of another, and
the reference voltage is set to be the lowest possible voltage to enable the amplifier in each bias circuit to operate in its high-gain common mode range.

14. The circuitry according to claim 13, wherein
the corresponding nodes are coupled for obtaining the drain voltages of the transistors.

15. The circuitry according to claim 1, wherein
the light emitting devices are light emitting diodes.

16. The circuitry according to claim 15, wherein
the light emitting diodes are white light emitting diodes.

17. The circuitry according to claim 1, wherein
the regulator is an inductor-based DC-DC converter.

18. The circuitry according to claim 17, wherein
the inductor-based DC-DC converter is a buck-boost DC-DC converter.

19. The circuitry according to claim 1, further comprising
a clamp circuit for preventing an excessive voltage from being applied to the output node.

20. Circuitry for controlling a regulator for regulating an output voltage to be supplied to an output node to which multiple light emitting devices are connected in parallel, in which each light emitting device is biased by a respective bias circuit, the circuitry comprising:
a detection circuit configured for receiving signals from the respective bias circuits, and in response, detecting which one of the light emitting devices being biased has the highest forward voltage drop based on the signals; and
a control circuit coupled to the detection circuit and configured for generating a control signal to control the regulator to produce substantially a lowest voltage effective to drive that one of the light emitting devices having the highest forward voltage drop.

21. The circuitry according to claim 20, wherein
the signals each indicate a voltage at a corresponding node in each bias circuit, and the node carrying the highest voltage among the corresponding nodes indicates which one of the light emitting devices being biased has the highest forward voltage drop, and
the detection circuit is configured for detecting the highest voltage.

22. The circuitry according to claim 21, wherein
the detection circuit comprises an OR-circuit including multiple NPN-transistors, bases of which receive the signals from the bias circuits, respectively, to output a voltage corresponding to the highest voltage.

23. The circuitry according to claim 21, wherein
the control circuit is configured for comparing the highest voltage detected by the detection circuit with a predetermined reference voltage, and in response, generating the control signal, and
the reference voltage is selected so as to control the regulator to produce substantially the lowest output voltage to drive that one of the light emitting devices having the highest forward voltage drop.

24. The circuitry according to claim 23, wherein
the control circuit comprises a first transconductance amplifier configured for sourcing or sinking a current as the control signal based on the difference between the highest voltage and the reference voltage.

25. The circuitry according to claim 24, further comprising
a second transconductance amplifier configured for sinking a predetermined amount of the current being sourced from the first transconductance amplifier when the output voltage at the output node exceeds a predetermined voltage.

26. The circuitry according to claim 23, wherein
the bias circuits each include MOS transistors and an amplifier for constituting a current mirror, in which a reference current is mirrored with a gain of K by the transistors to cause a current to flow through a light emitting device connected to the output node, drains of the transistors are connected to respective inputs of the amplifier, an output of the amplifier is connected to gates of the transistors, and the amplifier maintains drain and gate voltages of one of the transistors to be equal to those of another, and
the reference voltage is set to be the highest possible voltage to enable the amplifier in each bias circuit to operate in its high-gain common mode range.

27. The circuitry according to claim 26, wherein
the corresponding nodes are coupled for obtaining the gate voltages of the transistors.

28. The circuitry according to claim 20, wherein
the signals each indicate a voltage at a corresponding node in each bias circuit, and the node carrying the lowest voltage among the corresponding nodes indicates which one of the light emitting devices being biased has the highest forward voltage drop, and
the detection circuit is configured for detecting the lowest voltage.

29. The circuitry according to claim 28, wherein
the detection circuit comprises an OR-circuit including multiple PNP-transistors, bases of which receive the signals from the bias circuits, respectively, to output a voltage corresponding to the lowest voltage.

30. The circuitry according to claim 28, wherein
the control circuit is configured for comparing the lowest voltage detected by the detection circuit with a predetermined reference voltage, and in response, generating the control signal, and
the reference voltage is selected so as to control the regulator to produce substantially the lowest output voltage to drive that one of the light emitting devices having the highest forward voltage drop.

31. The circuitry according to claim 30, further comprising
a selector, connected between the detection circuit and the control circuit, for comparing the lowest voltage from the detection circuit with a scaled down voltage obtained by scaling down the output voltage at the output node to select the highest voltage, wherein
the control circuit is configured for comparing the highest voltage selected by the selector with the reference voltage.

32. The circuitry according to claim 30, wherein
the bias circuits each include MOS transistors and an amplifier for constituting a current mirror, in which a reference current is mirrored with a gain of K by the transistors to cause a current to flow through a light emitting device connected to the output node, drains of the transistors are connected to respective inputs of the amplifier, an output of the amplifier is connected to gates of the transistors, and the amplifier maintains drain and gate voltages of one of the transistors to be equal to those of another, and
the reference voltage is set to be the lowest possible voltage to enable the amplifier in each bias circuit to operate in its high-gain common mode range.

33. The circuitry according to claim 32, wherein
the corresponding nodes are coupled for obtaining the drain voltages of the transistors.

34. The circuitry according to claim 20, wherein
the light emitting devices are light emitting diodes.

35. The circuitry according to claim 34, wherein
the light emitting diodes are white light emitting diodes.

36. The circuitry according to claim 20, wherein
the regulator is an inductor-based DC-DC converter.

37. The circuitry according to claim 36, wherein
the inductor-based DC-DC converter is a buck-boost DC-DC converter.

38. The circuitry according to claim 20, further comprising
a clamp circuit for preventing an excessive voltage from being applied to the output node.

39. Circuitry comprising:
input nodes for receiving signals from bias circuits connected in series with multiple light emitting devices, respectively, the light emitting devices connected in parallel to a power supply node; and
a detection circuit, responsive to the signals on the input nodes, for detecting which one of the light emitting devices being biased has the highest forward voltage drop.

40. The circuitry according to claim 39, wherein
the signals each indicate a voltage at a corresponding node in each bias circuit, and the node carrying the highest voltage among the corresponding nodes indicates which one of the light emitting devices being biased has the highest forward voltage drop, and
the detection circuit is configured for detecting the highest voltage.

41. The circuitry according to claim 40, wherein
the detection circuit comprises an OR-circuit including multiple NPN-transistors, bases of which receive the signals from the input nodes, respectively, to output a voltage corresponding to the highest voltage.

42. The circuitry according to claim 40, wherein
the bias circuits each include MOS transistors and an amplifier for constituting a current mirror, in which a reference current is mirrored with a gain of K by the transistors to cause a current to flow through a light emitting device connected to the power supply node, drains of the transistors are connected to respective inputs of the amplifier, an output of the amplifier is connected to gates of the transistors, and the amplifier maintains drain and gate voltages of one of the transistors to be equal to those of another, and
the corresponding nodes are coupled for obtaining the gate voltages of the transistors.

43. The circuitry according to claim 39, wherein
the signals each indicate a voltage at a corresponding node in each bias circuit, and the node carrying the lowest voltage among the corresponding nodes indicates which one of the light emitting devices being biased has the highest forward voltage drop, and
the detection circuit is configured for detecting the lowest voltage.

44. The circuitry according to claim 43, wherein
the detection circuit comprises an OR-circuit including multiple PNP-transistors, bases of which receive the signals from the input nodes, respectively, to output a voltage corresponding to the lowest voltage.

45. The circuitry according to claim 43, wherein
the bias circuits each include MOS transistors and an amplifier for constituting a current mirror, in which a reference current is mirrored with a gain of K by the transistors to cause a current to flow through a light emitting device connected to the power supply node, drains of the transistors are connected to respective inputs of the amplifier, an output of the amplifier is connected to gates of the transistors, and the amplifier maintains drain and gate voltages of one of the transistors to be equal to those of another, and
the corresponding nodes are coupled for obtaining the drain voltages of the transistors.

46. The circuitry according to claim 39, wherein
the light emitting devices are light emitting diodes.

47. The circuitry according to claim 46, wherein
the light emitting diodes are white light emitting diodes.

48. A method for driving multiple light emitting devices connected in parallel to an output node and each connected in series to respective bias circuits for biasing the light emitting devices, the method comprising the steps of:
regulating an output voltage to be applied to the output node;
receiving signals from the respective bias circuits,
detecting which one of the light emitting devices being biased has the highest forward voltage drop based on the signals; and
generating a control signal to control the regulating step such that the output voltage is caused to attain the lowest voltage to drive that one of the light emitting devices having the highest forward voltage drop.

49. The method according to claim 48, wherein
the signals each indicate a voltage at a corresponding node in each bias circuit, and the node carrying the highest voltage among the corresponding nodes indicates which one of the light emitting devices being biased has the highest forward voltage drop, and
the detecting step detects the highest voltage.

50. The method according to claim 49, further comprising the step of
comparing the highest voltage detected in the detecting step with a predetermined reference voltage, the reference voltage being selected so as to produce substantially the lowest output voltage to drive that one of the light emitting devices having the highest forward voltage drop,
wherein the generating step generates the control signal based on the difference between the highest voltage and the reference voltage.

51. The method according to claim 50, wherein
the generating step includes sourcing or sinking a current as the control signal based on the difference between the highest voltage and the reference voltage.

52. The method according to claim 51, further comprising the step of
determining whether the output voltage at the output node exceeds a predetermined voltage, and
sinking a predetermined amount of the current being sourced by the generating step when the output voltage exceeds the predetermined voltage.

53. The method according to claim 50, wherein
the bias circuits each include MOS transistors and an amplifier for constituting a current mirror, in which a reference current is mirrored with a gain of K by the transistors to cause a current to flow through a light emitting device connected to the output node, drains of the transistors are connected to respective inputs of the amplifier, an output of the amplifier is connected to gates of the transistors, and the amplifier maintains drain and gate voltages of one of the transistors to be equal to those of another,
the method further comprising the step of
setting as the reference voltage the highest possible voltage to enable the amplifier in each bias circuit to operate in its high-gain common mode range.

54. The method according to claim 53, wherein
the receiving step obtains the gate voltages of the transistors from each of the bias circuit.

55. The method according to claim 48, wherein
the signals each indicate a voltage at a corresponding node in each bias circuit, and the node carrying the lowest voltage among the corresponding nodes indicates which one of the light emitting devices being biased has the highest forward voltage drop, and
the detecting step detects the lowest voltage.

56. The method according to claim 55, further comprising the step of
comparing the lowest voltage detected in the detecting step with a reference voltage, the reference voltage being selected so as to produce substantially the lowest output voltage to drive that one of the light emitting devices having the highest forward voltage drop,
wherein the generating step generates the control signal based on the difference between the reference voltage and the lowest voltage.

57. The method according to claim 56, further comprising the step of
scaling down the output voltage at the output node to obtain a scaled down voltage; and
comparing the lowest voltage detected in the detecting step with the scaled down voltage to select the higher one, wherein
the controlling step generates the control signal by comparing the higher one with the reference voltage.

58. The method according to claim 56, wherein
the bias circuits each include MOS transistors and an amplifier for constituting a current mirror, in which a reference current is mirrored with a gain of K by the transistors to cause a current to flow through a light emitting device connected to the output node, drains of the transistors are connected to respective inputs of the amplifier, an output of the amplifier is connected to gates of the transistors, and the amplifier maintains drain and gate voltages of one of the transistors to be equal to those of another, and
the method further comprising the step of
setting as the reference voltage the lowest possible voltage to enable the amplifier in each bias circuit to operate in its high-gain common mode range.

59. The method according to claim 58, wherein
the receiving step obtains the drain voltages of the transistors from each of the bias circuits.

60. Circuitry for driving multiple parallel-coupled light emitting devices connected to an output node, comprising:
a voltage regulator for controlling the output node; and
a control circuit for controlling the regulator to produce substantially a lowest output voltage effective to drive that one of the light emitting devices having the highest forward voltage drop.

61. Circuitry for driving multiple parallel-coupled light emitting devices connected to an output node, comprising:
a voltage regulator for controlling an output node;
bias circuitry for setting a level of current through each light emitting device;
the light emitting devices to be connected in circuit with the output node and bias circuitry; and
regulator control circuitry for controlling the voltage regulator to maintain an operating voltage across the bias circuitry to produce substantially a lowest output voltage effective to drive that one of the light emitting devices having the highest forward voltage drop.
